(19) United States
(12) Patent Application Publication
(10) Pub. No.: US 2022/0147364 A1
(43) Pub. Date: May 12, 2022

(54) SERVER BASEBOARD, SERVER, CONTROL METHOD, ELECTRONIC APPARATUS AND READABLE MEDIUM

(71) Applicant: Baidu Online Network Technology (Beijing) Co., Ltd., Beijing (CN)

(72) Inventors: Zhaogeng LI, Beijing (CN); Yong SHENG, Beijing (CN); Gang CHENG, Beijing (CN); Fangyao CHEN, Beijing (CN); Jie ZHAO, Beijing (CN)

(21) Appl. No.: 17/338,870

(22) Filed: Jun. 4, 2021

(30) Foreign Application Priority Data
Nov. 6, 2020 (CN) 202011235488.8

(51) Int. Cl. G06F 9/4401; G06F 13/40; G06F 21/62

(52) U.S. Cl. CPC G06F 9/4401; G06F 13/4022; G06F 2221/2141; G06F 2213/0052; G06F 21/6209

(57) ABSTRACT

The present disclosure provides a server baseboard, relates to the field of computer technology and can be applied to the fields of cloud computing and big data. A specific implementation scheme is that the server baseboard includes: a main control program module, a switch chip connected to the main control program module, and a plurality of physical network ports for connecting the switch chip to a management network and a baseboard other than the baseboard where the main control program module is located. The server baseboard can reduce the construction cost of the management network, and improve the availability of a server and the security of a service network. The present disclosure also provides a server, a control method, an electronic apparatus, and a readable medium.

### CROSS-REFERENCE TO RELATED APPLICATIONS

The present application claims the priority from Chinese Patent Application No. 202011235488.8, filed with the Chinese Patent Office on Nov. 6, 2020, the content of which is hereby incorporated herein by reference in its entirety.

### TECHNICAL FIELD

This disclosure relates to the field of computer technology, can be applied to the field of cloud computing and big data, and in particular relates to a server baseboard, a server, a control method, an electronic apparatus, and a readable medium.

### BACKGROUND

The development of cloud computing has brought a multi-baseboard server into a practical application stage. The multi-baseboard server refers to packaging multiple baseboards in a server box, and each baseboard has an independent processor system (which includes a CPU, a memory, and an interconnection bus) that can be used by different users. In the multi-baseboard server, each baseboard has an independent baseboard management controller (BMC), and each BMC can independently manage the baseboard where it is located.

### SUMMARY

Provided are a server baseboard, a server, a control method, an electronic apparatus, and a readable medium.

According to a first aspect, provided is a server baseboard including: a main control program module, the server baseboard further includes: a switch chip connected to the main control program module; and a plurality of physical network ports for connecting the switch chip to a management network and a baseboard other than the server baseboard where the main control program module is located.

According to a second aspect, provided is a server, including a main control baseboard and at least one non-main control baseboard, the main control baseboard employs the server baseboard provided in embodiments of the present disclosure, and the at least one non-main control baseboard is connected to the switch chip in the main control baseboard.

According to a third aspect, provided is a server control method based on the server provided in the embodiments of the present disclosure, including: receiving a management control instruction, the management control instruction including an access object identifier; and forwarding, by the switch chip, the management control instruction to a corresponding access object based on the access object identifier.

According to a fourth aspect, provided is an electronic apparatus, including: at least one processor; and a memory communicatively connected to the at least one processor. The memory stores an instruction executable by the at least one processor, and the instruction is executed by the at least one processor to cause the at least one processor to execute the method described in any one of the server control methods.

According to a fifth aspect, provided is a non-transitory computer-readable storage medium storing a computer instruction, and the computer instruction is used to cause the computer to execute any one of the server control methods described above.

According to the server baseboard provided by the embodiments of the present disclosure, the switch chip is connected to the management network and other baseboards other than the baseboard where the main control program module is located through physical network ports, and the management network is no longer provided with physical network ports connected to the other baseboards; that is, the management network has only one physical network port connected to the server, thereby reducing a number of physical network ports of the management network and reducing the construction cost of the management network. Also, the main control program module can realize signal transmission with the other baseboards through the switch chip without depending on the management network, thereby improving the availability of the server. In addition, the switch chip can isolate the management network and a service network, avoiding other servers from accessing the service network through the management network, and improving the security of the service network.

It should be understood that the content described in this section is not intended to identify key or important features of the embodiments of the present disclosure, nor is it intended to limit the scope of the present disclosure. Other features of the present disclosure will be easily understood from the following description.

### BRIEF DESCRIPTION OF THE DRAWINGS

The accompanying drawings are used to better understand the present solution, and do not constitute a limitation to the present disclosure.

FIG. 1 is an exemplary structure diagram of a server, a management network, and a service network according to an embodiment of the present disclosure.

FIG. 2 is a schematic structural diagram of a server baseboard provided according to an embodiment of the present disclosure.

FIG. 3 is a functional block diagram of a server provided according to an embodiment of the present disclosure.

FIG. 4 is a flowchart of a server control method provided according to an embodiment of the present disclosure.

FIG. 5 is another flowchart of a server control method provided according to an embodiment of the present disclosure.

FIG. 6 is a block diagram of an electronic apparatus used to implement the server control method of an embodiment of the present disclosure.

### DETAILED DESCRIPTION

The following describes exemplary embodiments of the present disclosure with reference to the accompanying drawings, where various details of the embodiments of the present disclosure are included to facilitate understanding, and should be considered as merely exemplary. Therefore, those of ordinary skill in the art should realize that various changes and modifications can be made to the embodiments described herein without departing from the scope and spirit of the present disclosure. Likewise, for clarity and conciseness, descriptions of well-known functions and structures are omitted in the following description.

In a case of no conflict, the embodiments of the present disclosure and the features in the embodiments can be combined with each other.

As used herein, the term “and/or” includes any and all combinations of one or more of the related listed items.

The terms used herein are only used to describe specific embodiments and are not intended to limit the present disclosure. As used herein, the singular forms “a”, “an” and “the” are also intended to include the plural forms, unless the context clearly dictates otherwise. It will also be understood that when the terms “comprise”, “comprising”, “include”, “including” and/or “made of” are used in this specification, they specify the presence of the described features, wholes, steps, operations, elements and/or components, but do not exclude the presence or addition of one or more other features, wholes, steps, operations, elements, components, and/or groups thereof.

In a multi-baseboard server, a baseboard is selected as a main control baseboard to assume a main control function, and to control non-main control baseboards (the remaining baseboards). In addition, the physical isolation between the main control baseboard and the non-main control baseboards as well as the physical isolation between different non-main control baseboards are capable of realizing cloud-based delivery of computing resources while avoiding virtualization overhead.

However, in the multi-baseboard server, not only the main control baseboard is connected to a management network through a network interface, but also each non-main control baseboard can be connected to the management network through a network interface, that is, the main control baseboard and the non-main control baseboards are independently connected to the management network. Therefore, when the density of baseboards in the multi-baseboard server becomes higher, since each baseboard management controller independently accesses the management network, the cost of the management network will be greatly increased, the main control baseboard may lose direct control of the remaining baseboards, and at the same time the isolation characteristics of the management network may be affected.

Since each baseboard in the multi-baseboard server is connected to the management network, the management network has more interfaces, and the number of the interfaces of the management network is at least equal to that of baseboards in the multi-baseboard server, resulting in a higher construction cost for the management network. Moreover, the main control baseboard may communicate with baseboards of other multi-baseboard servers through the management network. Therefore, in actual applications, additional authentication and authorization mechanisms are required to ensure the safety of the multi-baseboard server; at the same time, the main control baseboard realizes connectivity between the management network and a service network, which brings risks to the security of the service network. In addition, since the main control baseboard and the non-main control baseboards depend on the control of the management network, when the management network fails, the main control baseboard cannot control the non-main control baseboards, which affects the usability of the multi-baseboard server.

As used herein, the management network is a network used by technicians to manage the server, and the service network is a way for the server to provide functions to the outside.

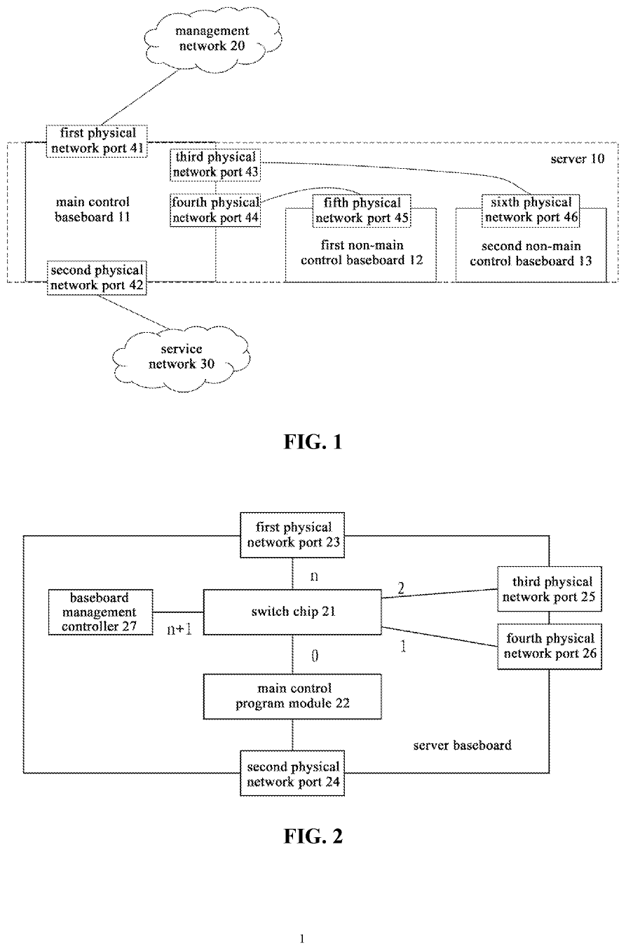

FIG. 1 is an exemplary structure diagram of a server, a management network, and a service network according to an embodiment of the present disclosure. Referring to FIG. 1, the server 10 is connected to the management network 20 and the service network 30 through physical network ports, so as to realize signal transmission between the server 10 and the management network 20 and the service network 30.

The server 10 includes three server baseboards, one of which is a main control baseboard 11, and the remaining two of which are a first non-main control baseboard 12 and a second non-main control baseboard 13. The main control baseboard 11 is in signal connection with the management network 20 through a first physical network port 41, and is in signal connection with the service network 30 through a second physical network port 42. The first non-main control baseboard 12 is in signal connection with a fourth physical network port 44 disposed on the main control baseboard 11 through a fifth physical network port 45 disposed thereon, thereby being indirectly connected to the management network 20 and the service network 30. The second non-main control baseboard 13 is in signal connection with a third physical network port 43 disposed on the main control baseboard 11 through a sixth physical network port 46 disposed thereon, thereby being indirectly connected to the management network 20 and the service network 30. According to the present disclosure, it is mainly to improve the server baseboard, especially the server baseboard as the main control baseboard, so as to reduce the construction cost of the management network, and improve the availability of the server and the security of the service network.

In a first aspect, an embodiment of the present disclosure provides a server baseboard. FIG. 2 is a schematic structural diagram of a server baseboard provided according to an embodiment of the present disclosure.

Referring to FIG. 2, the server baseboard provided according to the embodiment of the present disclosure includes a switch chip 21, a main control program module 22, a first physical network port 23, a second physical network port 24, a third physical network port 25, and a fourth physical network port 26. The switch chip 21 is connected to the main control program module 22. The switch chip 21 is in signal connection with a management network through the first physical network port 23, to realize information interaction with the management network. The switch chip 21 is in signal connection with other server baseboards in the server through the third physical network port 25 and the fourth physical network port 26.

The main control program module 22 is in signal connection with a service network through the second physical network port 24, to realize information interaction with the service network. The main control program module 22 is used to monitor and manage the current baseboard and other baseboards in the server.

In some embodiments, the switch chip 21 may be set to block the communication between port 0 and port n, that is, to block the main control program module 22 from accessing server baseboards of other servers, thereby improving the security of the service network.

For example, a user may configure the switch chip by using Access Control List (ACL) rules to block the communication between port 0 and port n, thereby blocking the communication between the management network and the main control program module. The server isolates the management network from the service network by means of the switch chip 21, and the main control program module 22 can only access the server baseboards in the server, and cannot access the server baseboards in the other servers, thereby preventing the other servers from accessing the service network through the management network, to further improve the security of the service network.

In some embodiments, the server baseboard further includes a baseboard management controller 27, and the baseboard management controller 27 is in signal connection with the switch chip 21. The baseboard management controller 27 is used for, but is not limited to, local and remote diagnosis, console support, configuration management, hardware management, and troubleshooting. The management network can control the baseboard management controller 27 through the switch chip 21.

It should be noted that the server baseboard technology mentioned in the embodiment of the present disclosure that uses the switch chip 21 to block the main control program module 22 from accessing the other servers can not only be applied to the server baseboard, but can be independent of the server baseboard and be applied to the server as a smart network card.

According to the server baseboard provided by the embodiments of the present disclosure, the switch chip is connected to the management network and other baseboards other than the baseboard where the main control program module is located through physical network ports, and the management network no longer needs to be provided with interfaces connected to other baseboards in the server, that is, the management network has only one physical network port connected to the server, thereby reducing the number of physical network ports of the management network and reducing the construction cost of the management network. Also, the main control program module can realize signal transmission with other baseboards through the switch chip without depending on the management network, thereby improving the availability of the server. In addition, the switch chip can isolate the management network and the service network, avoiding the other servers from accessing the service network through the management network, and improving the security of the service network.

In a second aspect, an embodiment of the present disclosure provides a server, which can perform signal interaction with the management network and the service network, reduce the number of physical network ports of the management network and the construction cost of the management network, and improve the availability of the server and the security of the service network.

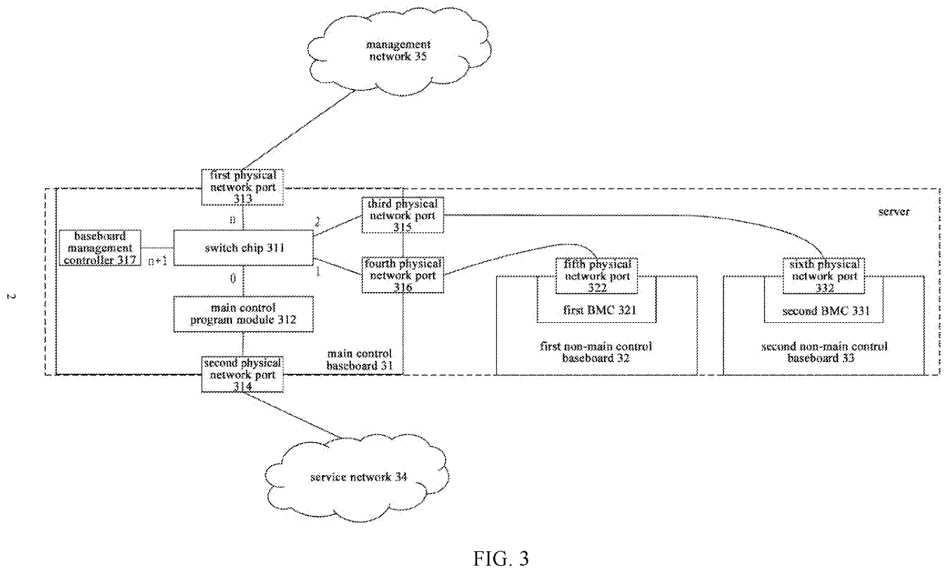

FIG. 3 is a functional block diagram of a server provided according to an embodiment of the present disclosure. Referring to FIG. 3, the server includes a main control baseboard 31, a first non-main control baseboard 32, and a second non-main control baseboard 33. The main control baseboard 31 employs the server baseboard provided by the embodiments of the present disclosure.

In some embodiments, the main control baseboard 31 includes a switch chip 311, a main control program module 312, and a plurality of physical network ports, i.e., a first physical network port 313, a second physical network port 314, a third physical network port 315, and a fourth physical network ports 316. The switch chip 311 is connected to the main control program module 312, and the first physical network port 313, the second physical network port 314, the third physical network port 315 and the fourth physical network port 316 are connected to the switch chip 311. The switch chip 311 is in signal connection with a management network 35 through the first physical network port 313, to realize information interaction with the management network 35. The switch chip 311 is in signal connection with the first non-main control baseboard 32 in the server through the fourth physical network port 316, and is in signal connection with the second non-main control baseboard 33 in the server through the third physical network port 315, that is, each non-main control baseboard corresponds to one physical network port.

The main control program module 312 is connected to a service network 34 through the second physical network port 314, to realize information interaction with the service network 34.

In some embodiments, the first non-main control baseboard 32 includes a first non-main control baseboard management controller (BMC) 321 and a fifth physical network port 322, the first non-main control baseboard management controller 321 is connected to the fifth physical network port 322, and the fifth physical network port 322 is connected to the fourth physical network port 316 on the main control baseboard 31, so that the first non-main control baseboard 32 is connected to the switch chip 311. The main control program module 312 may access the first non-main control baseboard management controller 321, i.e., access the first non-main control baseboard 32 through the switch chip 311, the fourth physical network port 316 and the fifth physical network port 322. Therefore, the first non-main control baseboard 32 can be accessed either through the main control program module 312 or through the management network 35.

The second non-main control baseboard 33 includes a second non-main control baseboard management controller (BMC) 331 and a sixth physical network port 332. The second non-main control baseboard management controller 331 is connected to the sixth physical network port 332, and the sixth physical network port 332 is connected to the third physical network port 315 on the main control baseboard 31, so that the second non-main control baseboard 33 is connected to the switch chip 311. The main control program module 312 can access the second non-main control baseboard management controller 331, i.e., access the second non-main control baseboard 33 through the switch chip 311, the third physical network port 315, and the sixth physical network port 332. Therefore, the second non-main control baseboard 33 can be accessed either through the main control program module 312 or through the management network 35.

In some embodiments, the switch chip 311 may be set to block the communication between port 0 and port n, i.e., to block the main control program module 312 from accessing main control baseboards and non-main control baseboards of other servers. The server isolates the management network 35 from the service network 34 by means of the switch chip 311, and the main control program module 312 can only access the first non-main control baseboard 32 and the second non-main control baseboard 33 in the server, and cannot access the main control baseboards and non-main control baseboards in the other servers, thereby preventing the other servers from accessing the service network 34 through the management network 35, to further improve the security of the service network 34.

For example, the switch chip is configured by using ACL rules to block the communication between port 0 and port n, thereby blocking the communication between the management network and the main control program module.

In some embodiments, the main control baseboard 311 further includes a baseboard management controller 317, and the baseboard management controller 317 is in signal connection with the switch chip 311. The baseboard management controller 317 is used for, but is not limited to, local and remote diagnosis, console support, configuration management, hardware management, and troubleshooting. The management network 35 can control the baseboard management controller 317 through the switch chip 311.

In some embodiments, the switch chip 311 is set to block the communication between port n+1 and port 0, the baseboard management controller 317 of the main control baseboard 31 and the first non-main control baseboard management controller 321 of the first non-main control baseboard 32 both can be accessed through the management network 35, but the main control program module 312 can only access the first non-main control baseboard management controller 321 in the server. At the same time, the baseboard management controller 317 of the main control baseboard 31 and the second non-main control baseboard management controller 331 of the second non-main control baseboard 33 both can be accessed through the management network 35, but the main control program module 312 can only access the second non-main control baseboard management controller 331 in the server.

In some embodiments, the switch chip 311 can be disposed on the main control baseboard 31, or can be disposed on the outside of the main control baseboard 31, that is, independent of the main control baseboard 31, but the switch chip 311 is still in signal connection with the main control program module 312 and the second physical network port 314.

It should be noted that the server provided in this embodiment is provided with the first non-main control baseboard 32 and the second non-main control baseboard 33. This is only an exemplary description of the server, and does not mean that the number of the non-main control baseboards in the server is limited thereto.

According to the server provided by the embodiments of the present disclosure, the switch chip on the main control baseboard is connected to the management network and the non-main control baseboards through the physical network ports respectively. The management network is no longer provided with physical network ports connected to other baseboards, that is, the management network has only one physical network port connected to the server, reducing the number of the physical network ports of the management network and reducing the construction cost of the management network. Also, the main control program module can realize signal transmission with the non-main control baseboards through the switch chip without depending on the management network, thereby improving the availability of the server. In addition, the switch chip can isolate the management network and the service network, avoiding the other servers from accessing the service network through the management network, and improving the security of the service network.

In a third aspect, an embodiment of the present disclosure provides a server control method, which can perform signal interaction with a management network and a service network, reduce the number of physical network ports of the management network and the construction cost of the management network, and improve the availability of the server and the security of the service network.

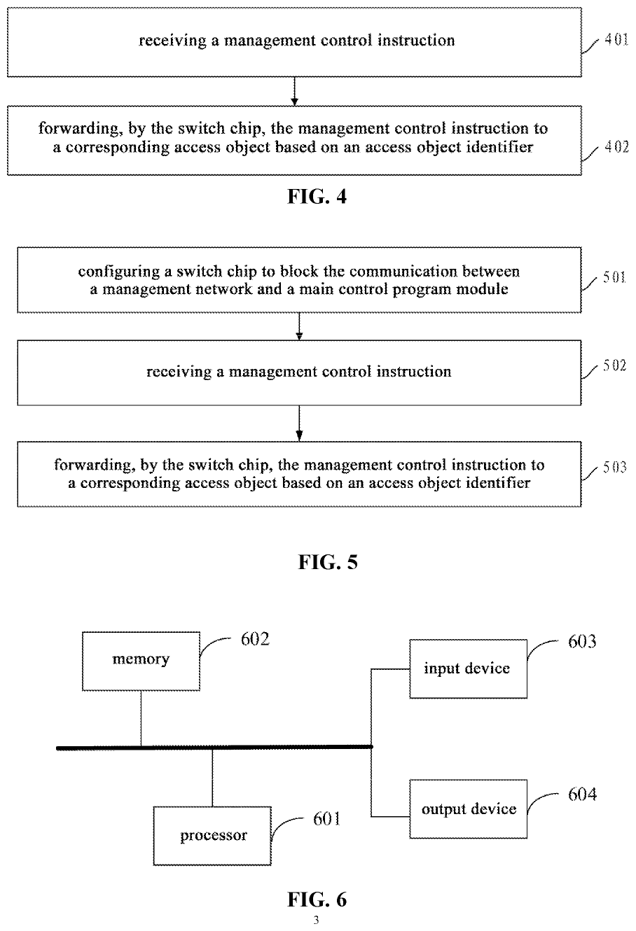

FIG. 4 is a flowchart of a server control method provided according to an embodiment of the present disclosure. Referring to FIGS. 3 and 4, the server control method includes the following steps.

In step 401, a management control instruction is received.

The management control instruction may be from the management network or a main control program module on a main control baseboard in the server. The management control instruction includes an access object identifier, and an access object accessed by the management network may be determined based on the access object identifier.

In step 402, the management control instruction is forwarded to a corresponding access object by the switch chip based on the access object identifier.

In some embodiments, the management network sends the management control instruction to the switch chip in the main control baseboard through a physical network port. The switch chip determines the access object based on the access object identifier in the management control instruction, and then sends the management control instruction to the access object corresponding to the instruction.

The access object may be the main control baseboard or a non-main control baseboard in the server.

For example, if the management network needs to access the first non-main control baseboard 32, and an identifier of the first non-main control baseboard 32 is service1, the management control instruction includes service1. The management network sends the management control instruction to the switch chip 311 in the main control baseboard through the second physical network port 314. The switch chip 311 determines the first non-main control baseboard 32 based on the access object identifier service1 in the management control instruction, and then sends the management control instruction to the first non-main control baseboard 32 through the fourth physical network port 316 and the fifth physical network port 322.

In some embodiments, as shown in FIG. 5, the server control method includes the following steps.

In step 501, the switch chip is configured to block the communication between the management network and the main control program module.

In some embodiments, the switch chip is configured by using ACL rules to block the communication between port 0 and port n, thereby blocking the communication between the management network and the main control program module.

The server isolates the management network from the service network by means of the switch chip, and the main control program module can only access non-main control baseboards in the server, and cannot access main control baseboards and non-main control baseboards in other servers, thereby preventing the other servers from accessing the service network through the management network, to further improve the security of the service network.

In step 502, a management control instruction is received.

where the management control instruction may be from the management network or the main control program module on a main control baseboard in the server. The management control instruction includes an access object identifier, and an access object accessed by the management network may be determined based on the access object identifier.

In step 503, the management control instruction is forwarded to a corresponding access object by the switch chip based on the access object identifier.

In some embodiments, the management network sends the management control instruction to the switch chip in the main control baseboard through a physical network port. The switch chip determines the access object based on the access object identifier in the management control instruction, and then sends the management control instruction to the access object corresponding to the instruction.

The access object may be the main control baseboard or a non-main control baseboard in the server.

For example, when the management network needs to access a non-main control baseboard in the server, the management network sends the management control instruction to the switch chip in the main control baseboard through the physical network port, the switch chip determines the non-main control baseboard based on the access object identifier in the management control instruction, and then sends the management control instruction to the non-main control baseboard.

According to the server control method provided by the embodiments of the present disclosure, the switch chip on the main control baseboard is connected to the management network and the non-main control baseboards through the physical network ports respectively. The management network has only one physical network port connected to the server, reducing the number of the physical network ports of the management network and reducing the construction cost of the management network. Also, the main control program module can realize signal transmission with the non-main control baseboards through the switch chip without depending on the management network, thereby improving the availability of the server. In addition, the switch chip can isolate the management network and the service network, avoiding the other servers from accessing the service network through the management network, and improving the security of the service network.

According to the embodiments of the present disclosure, the present disclosure also provides an electronic apparatus and a readable storage medium.

As shown in FIG. 6, it is a block diagram of an electronic apparatus used to implement the server control method of an embodiment of the present disclosure. The electronic apparatus is intended to represent various forms of digital computers, such as a laptop computer, a desktop computer, a workstation, a personal digital assistant, a server, a blade server, a mainframe computer, and other suitable computers. The electronic apparatus may also represent various forms of mobile devices, such as a personal digital assistant, a cellular phone, a smart phone, a wearable apparatus, and other similar computing devices. The components shown herein, their connections and relationships, as well as their functions are merely examples, and are not intended to limit the implementation of the present disclosure described and/or claimed herein.

As shown in FIG. 6, the electronic apparatus includes at least one processor 601, a memory 602, and interfaces for connecting various components, including high-speed interfaces and low-speed interfaces. The various components are connected to each other using different buses, and can be installed on a common baseboard or installed in other ways as needed. The processor may process instructions executed in the electronic apparatus, including instructions stored in or on the memory to display graphical information of GUI on an external input/output device (e.g., a display apparatus coupled to an interface). In other implementations, if necessary, a plurality of processors and/or a plurality of buses can be used together with a plurality of memories. Similarly, a plurality of electronic apparatuses may be connected, and each apparatus provides some necessary operations (e.g., used as a server array, a group of blade servers, or a multi-processor system). In FIG. 6, a processor 601 is taken as an example.

The memory 602 is a non-transitory computer-readable storage medium provided according to the present disclosure. The memory stores instructions that can be executed by the at least one processor, to cause the at least one processor to execute the server control method provided according to the present disclosure. The non-transitory computer-readable storage medium of the present disclosure stores computer instructions, and the computer instructions are used to cause a computer to execute the server control method provided according to the present disclosure.

As the non-transitory computer-readable storage medium, the memory 602 can be used to store non-transitory software programs, non-transitory computer executable programs, and modules, such as program instructions/modules corresponding to the server control method according to the embodiments of the present disclosure. The processor 601 executes various functional applications and data processing of the server, i.e., implementing the server control method according to the foregoing method embodiments, by performing non-transitory software programs, instructions, and modules stored in the memory 602.

The memory 602 may include a program storage area and a data storage area. The program storage area may store an operating system and an application program required by at least one function. The data storage area may store data created based on the use of a server-controlled electronic apparatus. In addition, the memory 602 may include a high-speed random access memory, and may also include a non-transitory memory, such as at least one magnetic disk storage device, a flash memory device, or other non-transitory solid-state storage devices. In some embodiments, the memory 602 may optionally include storages remotely disposed relative to the processor 601, and these remote storages may be connected to the server-controlled electronic apparatus through a network. Examples of the aforementioned network include, but are not limited to, Internet, an intranet, a local area network, a mobile communication network, and combinations thereof.

The electronic apparatus for the server control method may further include an input device 603 and an output device 604. The processor 601, the memory 602, the input device 603 and the output device 604 may be connected through a bus or in other ways. In FIG. 6, a connection through a bus is taken as an example.

The input device 603 may receive input digital or character information, and generate key signal input related to the user settings and function control of the server-controlled electronic apparatus, such as a touch screen, a keypad, a mouse, a trackpad, a touchpad, an indicator stick, one or more mouse buttons, a trackball, a joystick, and the like. The output device 604 may include a display apparatus, an auxiliary lighting device (e.g., LED), a tactile feedback device (e.g., a vibration motor), and the like. The display apparatus may include, but is not limited to, a liquid crystal display (LCD), a light emitting diode (LED) display, and a plasma display. In some embodiments, the display apparatus may be a touch screen.

Various implementations of the systems and technologies described herein can be implemented in a digital electronic circuit system, an integrated circuit system, an application-specific integrated circuit (ASIC), computer hardware, firmware, software, and/or combinations thereof. These various implementations may include being implemented in one or more computer programs, the one or more computer programs may be performed and/or interpreted on a programmable system including at least one programmable processor, and the programmable processor may be a special-purpose or general-purpose programmable processor, may receive data and instructions from a storage system, at least one input device, and at least one output device, and transmit the data and instructions to the storage system, the at least one input device, and the at least one output device.

These computer programs (also called programs, software, software application, or code) include machine instructions of a programmable processor, and may be implemented using high-level procedure and/or object-oriented programming languages, and/or assembly/machine language. As used herein, the terms “machine-readable medium” and “computer-readable medium” refer to any computer program product, apparatus, and/or device (e.g., a magnetic disk, an optical disk, a memory, a programmable logic device (PLD)) used to provide machine instructions and/or data to a programmable processor, including a machine-readable medium that receive machine instructions as machine-readable signals. The term “machine-readable signal” refers to any signal used to provide machine instructions and/or data to a programmable processor.

In order to provide interaction with the user, the systems and technologies described herein can be implemented on a computer that has: a display apparatus for displaying information to the user (e.g., a cathode ray tube (CRT) or a liquid crystal display (LCD) monitor)); and a keyboard and a pointing device (e.g., a mouse or a trackball) through which the user can provide input to the computer. Other types of devices may also be used to provide interaction with the user. For example, feedback provided to the user can be any form of sensory feedback (e.g., visual feedback, auditory feedback, or tactile feedback); and it is capable of receiving input from the user in any form (including acoustic input, voice input, or tactile input).

The systems and technologies described herein can be implemented in a computing system that includes back-end components (e.g., as a data server), a computing system that includes middleware components (e.g., as an application server), a computing system that includes front-end components (e.g., as a user computer with a graphical user interface or web browser through which the user can interact with the implementation of the systems and technologies described herein), or a computing system that includes any combination of the back-end components, middleware components, or front-end components. The components of the system can be connected to each other through any form or kind of digital data communication (e.g., a communication network). Examples of the communication network include a local area network (LAN), a wide area network (WAN), and the Internet.

A computer system may include a client and a server. The client and server are generally far away from each other and usually interact through a communication network. The server can also be a server of a distributed system or a server combined with a blockchain, and the relationship between the client and the server is generated through computer programs performed on a corresponding computer and having a client-server relationship with each other.

It should be understood that various forms of processes shown above can be used to reorder, add or delete steps. For example, steps described in the present disclosure can be executed in parallel, sequentially, or in a different order, as long as the desired result of the technical solution disclosed in the present disclosure can be achieved, and this is not limited herein.

The foregoing specific implementations do not constitute a limitation on the protection scope of the present disclosure. Those of ordinary skill in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

1. A server baseboard comprising a main control program module, wherein the server baseboard further comprises:
a switch chip connected to the main control program module; and
a plurality of physical network ports for connecting the switch chip to a management network and a baseboard other than the server baseboard where the main control program module is located.

2. The server baseboard of claim 1, further comprising a baseboard management controller, wherein the baseboard management controller is connected to the switch chip.

3. A server comprising a main control baseboard and at least one non-main control baseboard, wherein the main control baseboard employs the server baseboard of claim 1, and the at least one non-main control baseboard is connected to the switch chip in the main control baseboard.

4. A server comprising a main control baseboard and at least one non-main control baseboard, wherein the main control baseboard employs the server baseboard of claim 2, and the at least one non-main control baseboard is connected to the switch chip in the main control baseboard.

5. The server of claim 3, wherein the at least one non-main control baseboard is connected to the switch chip in the main control baseboard through the plurality of physical network ports.

6. The server of claim 3, wherein the at least one non-main control baseboard is provided with a non-main control baseboard management controller, and the switch chip has a physical network port connected to the at least one non-main control baseboard controller.

7. A server control method based on the server of claim 3, comprising:
receiving a management control instruction, wherein the management control instruction comprises an access object identifier; and
forwarding, by the switch chip, the management control instruction to a corresponding access object based on the access object identifier.

8. A server control method based on the server of claim 4, comprising:
receiving a management control instruction, wherein the management control instruction comprises an access object identifier; and
forwarding, by the switch chip, the management control instruction to a corresponding access object based on the access object identifier.

9. A server control method based on the server of claim 5, comprising:
receiving a management control instruction, wherein the management control instruction comprises an access object identifier; and
forwarding, by the switch chip, the management control instruction to a corresponding access object based on the access object identifier.

10. A server control method based on the server of claim 6, comprising:
receiving a management control instruction, wherein the management control instruction comprises an access object identifier; and
forwarding, by the switch chip, the management control instruction to a corresponding access object based on the access object identifier.

11. The method of claim 7, wherein the management control instruction is from the management network or the main control program module.

12. The method of claim 7, wherein the access object comprises the main control baseboard and the at least one non-main control baseboard.

13. The method of claim 7, before receiving the management control instruction, further comprising:
configuring the switch chip to block communication between the management network and the main control program module.

14. An electronic apparatus, comprising:
at least one processor; and
a memory communicatively connected to the at least one processor;
wherein the memory stores an instruction executable by the at least one processor, and the instruction is executed by the at least one processor to cause the at least one processor to:
receive a management control instruction, wherein the management control instruction comprises an access object identifier; and
forward, by the switch chip, the management control instruction to a corresponding access object based on the access object identifier.

15. The electronic apparatus of claim 14, wherein the management control instruction is from the management network or the main control program module.

16. The electronic apparatus of claim 14, wherein the access object comprises the main control baseboard and the at least one non-main control baseboard.

17. The electronic apparatus of claim 14, the at least one processor is further configured to configure the switch chip to block communication between the management network and the main control program module before receiving the management control instruction.

18. A non-transitory computer-readable storage medium storing a computer instruction, wherein the computer instruction is used to cause a computer to execute the method of claim 7.
